(19) United States
(12) Patent Application Publication
(10) Pub. No.: US 2016/0314653 A1
(43) Pub. Date: Oct. 27, 2016

(54) Systems and Methods for Hosting User-Defined Proposition Games

(71) Applicant: SB Technologies Ltd., Belize City (BZ)

(72) Inventor: Ari LEWSKI, Caulfield South (AU)

(21) Appl. No.: 14/695,749

(22) Filed: Apr. 24, 2015

(51) Int. Cl. G07F 17/32

(52) U.S. Cl. CPC G07F 17/3239; G07F 17/3276

(57) ABSTRACT

A plurality of users are registered for a competition, wherein registering the plurality of users comprises assigning each of the plurality of users a set number of points. At least one proposition pick is received from each of the plurality of users, wherein receiving the at least one proposition pick from each of the plurality of users comprises receiving terms of the proposition pick and a subset of each user's assigned points. An offer is generated for the at least one proposition pick from each of the plurality of users. The offer is presented to each of the plurality of users. An acceptance of the offer is received from each of the plurality of users. Results are determined for each of the plurality of proposition picks. The plurality of users are ranked based upon the results of each of the proposition picks, the offer for each of the proposition picks, and the subset of each user's assigned points.

### TECHNICAL FIELD

The present disclosure relates to games, and in particular, games between users in which the results of the game are based on user-defined propositions.

### BACKGROUND

A fantasy sport (also known as rotisserie, roto, or owner simulation) is a game where participants act as owners to build a team that competes against other fantasy owners based on the statistics generated by the real individual players or teams of a professional sport. These fantasy leagues are, by their very nature, rigidly structured. Specifically, these leagues have specific rules and ways of calculating winners to which each and every participant in a particular league is strictly bound. In fantasy sports leagues, each user attempts to maximize specific goals that are common to all of the participants, e.g., yards, points, completions, interceptions, etc. In season-long and day-long fantasy leagues, users are limited to selecting individual players and/or teams that they think will be successful within these limited categories. Furthermore, these leagues are generally limited to a single sport.

### BRIEF DESCRIPTION OF THE DRAWINGS

FIG. 1 is a flowchart illustrating a method for participating in an “active” competition with user-defined propositions, according to an example embodiment.

FIG. 2 is a flowchart illustrating a method for participating in an “inactive” competition with user-defined propositions, according to an example embodiment.

FIG. 3 is a flowchart illustrating a method for hosting an “active” competition with user-defined propositions, according to an example embodiment.

FIG. 4 is a flowchart illustrating a method for hosting an “inactive” competition with user-defined propositions, according to an example embodiment.

FIG. 5 is a flowchart illustrating a method for hosting a competition with user-defined propositions, according to an example embodiment.

FIG. 6 is a flowchart illustrating a second method for hosting a competition with user-defined propositions, according to an example embodiment.

FIG. 7 is an example interactive game board for selecting games with user-defined propositions, according to an example embodiment.

FIG. 8 is an example interactive game board for constructing user-defined propositions for use in games, according to an example embodiment.

FIG. 9 is an example apparatus configured to host a competition with user-defined propositions, according to an example embodiment.

### DESCRIPTION OF EXAMPLE EMBODIMENTS

### Overview

A plurality of users are registered for a competition, wherein registering the plurality of users comprises assigning each of the plurality of users a set number of points. At least one proposition pick is received from each of the plurality of users, wherein receiving the at least one proposition pick from each of the plurality of users comprises receiving terms of the proposition pick and a subset of each user's assigned points. An offer is generated for the at least one proposition pick from each of the plurality of users. The offer is presented to each of the plurality of users. An acceptance of the offer is received from each of the plurality of users. Results are determined for each of the plurality of proposition picks. The plurality of users are ranked based upon the results of each of the proposition picks, the offer for each of the proposition picks, and the subset of each user's assigned points.

### Example Embodiments

According to example embodiments of the present disclosure, systems and methods are presented for hosting and managing a competition between a plurality of users. Specifically, the systems and methods described herein execute a new form of game, particularly, a league based system in which competitors compete against each other based upon user defined propositions or “prop picks.” As used herein, a “prop pick” is a prediction regarding an occurrence or non-occurrence during an event. For example, during a sporting event, a “prop pick” may include the prediction of the occurrence or non-occurrence of an event that does not affect the sporting event's final outcome. In the context of an awards show, a “prop pick” may include a prediction of the occurrence or non-occurrence of an event other than the ultimate winner of a particular category. Furthermore, “prop picks” can span multiple related or unrelated events. For example, a “prop pick” may include predicting a number of points scored by a player over a series of games, regardless of the actual outcome of any one of the games.

Unlike other uses of prop picks, in which an individual user selects from different prop picks, in which multiple users define odds through their wagers placed on single prop picks, the game disclosed herein allows different users to be compared and ranked even though each user may select completely different prop picks. Accordingly, through the use of the techniques described herein, a non-routine, non-conventional, novel form of competition is presented.

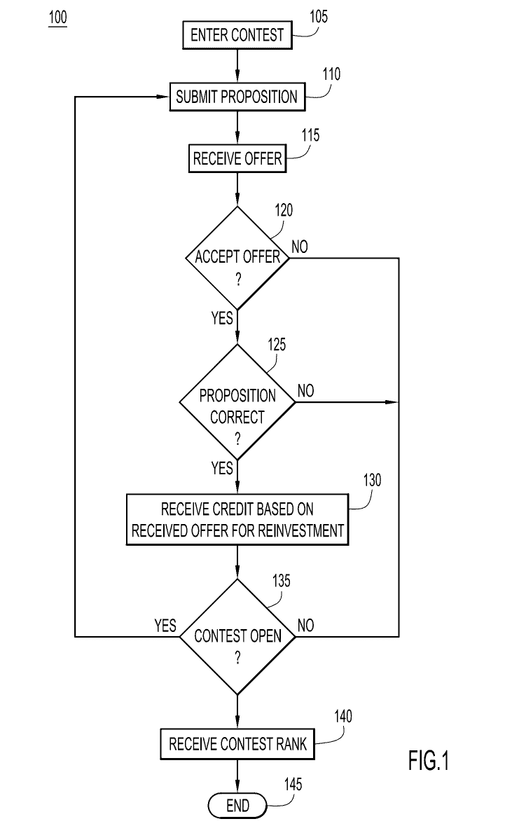

With reference to FIG. 1, depicted therein is a process for competing in a game according to the techniques described herein, in which the users create and selects their own prop picks and select their own “wager” amounts in the form of points or virtual currency assigned to the pick, but is nevertheless ranked against different users who may select different prop picks and who assign different numbers of points or virtual currency to their picks. Accordingly, while the processing of FIG. 1 is directed to the steps performed by a single contestant within a contest, additional users will be performing analogous actions as they participate in the contest against the user of FIG. 1.

Specifically, FIG. 1 illustrates a flow chart 100 for a process that begins when the user enters a contest in 105. The contest of flowchart 100 will pit the user against other users, but does so in a way that each user will be able to select not only his or her own desired outcome of a particular prop pick, but the terms of his or her desired prop picks as well. Entering in the contest may result in the user being assigned a predetermined number of points to use in the contest. Specifically, these points will serve as a wager or scaling factor for the proposition picks the user makes. In other words, the points may serve as the user's “budget” for the prop picks that will be placed during the competition. Entering the contest may also include the user depositing money into a virtual “wallet” that the user can use to pay entrance fees to different contests.

In 110, the user submits a proposition pick. This “prop pick” may be determined by the user, or alternatively, the user may select the prop pick from a set of predetermined prop picks provided to the user as part of the contest. For example, if the contest has a sports theme, the user may submit a statistic based prop pick, such as “LeBron James will score 25 or more points against Chicago.” Other types of prop picks include head-to-head prop picks, such as “Tom Brady will have more touchdown passes than Payton Manning in week 12.” Users can also submit combination prop picks, such as “Kobe Bryant and Kevin Durant combined will score 6 or more three-pointers on Jan. 1, 2015.”

In other words, the contest is more flexible and is differently structured than other multi-user competitions, such as fantasy sport leagues. In fantasy sports leagues, each user attempts to maximize specific goals that are common to all of the participants, e.g., yards, points, completions, interceptions, etc. In season-long and day-long fantasy leagues, users are limited to selecting individual players and/or teams that they think will be successful within these limited categories. Furthermore, these leagues are generally limited to a single sport. According to the competition of the present example embodiment, the user is provided with more freedom to select the goals, players, sports, etc., for the proposition picks placed in 110.

The submission of the prop pick in 110 may include a number of the user's points that the user would like to use to scale the importance or confidence in a particular prop pick. For example, if a user is confident in the outcome of a particular prop pick, the user may indicate that confidence by assigning a high percentage of his or her budget to the prop pick. On the other hand, if the user is less confident in his or her predicted outcome, fewer points may be assigned to a particular prop pick.

In 115, the user is presented with odds or an offer for the prop pick submitted in 110. As used herein, “offer” refers to a numeric value related to the probable outcome of a particular prop pick. For example, if it is determined that a prop pick submitted by a user in 110 is likely to occur, the offer generated for that prop pick will be a numeric value that indicates a likelihood or probability that the predicted outcome of the prop pick will come to pass. A prop pick with a highly likely outcome may receive a lower numeric value than a prop pick with a less likely outcome. According to other example embodiments, the prop pick with the more likely outcome may receive an offer with a higher numeric value, depending on the manner in which the numeric value is used to rank competitors, as will be described in greater detail with reference to reference numeral 140.

If the user included his or her assigned number of points or virtual currency when submitting the prop pick in 110, the amount of the offer presented to the user in 115 may have taken into account the magnitude of the user's assigned points or virtual currency. According to other example embodiments, the user may wait to assign his or her points or virtual currency to the prop pick until after he or she is presented with the offer.

In 120, the user may select whether or not to accept the offer. If the user did not present his or her proposed number of points or virtual currency when the prop pick was submitted in 110, the user may determine and submit his or her desired number of points or virtual currency to associate with the prop pick as a scaling factor when he or she accepts the prop pick at 120.

If the user declines the offer, and therefore the prop pick, the process of flow chart 100 will jump ahead to 135, which will be described in greater detail below. On the other hand, if the user accepts the offer associated with the prop pick, the processing of flow chart 100 moves to 125. In 125, a determination is made as to whether or not the user's prop pick resulted as the user predicted. If the user incorrectly predicts the outcome of the prop pick, the processing of flowchart 100 jumps to 135. On the other hand, if the user correctly predicted the outcome of the prop pick, the user receives credit in 130 based on a combination of the offer the user received for the prop pick and the number of points or virtual currency that the user assigned to the prop pick. For example, if the host assigns offers with high numeric values to prop picks with low likelihoods of coming to pass, the number of points the user assigned to the prop pick may be multiplied by the numeric value of the offer the user received on the prop pick. In other embodiments in which the host assigns low numeric values to offers with low likelihoods of coming to pass (e.g., a percentage indicating the likelihood of the predicted outcome), the number of points the user assigned to the prop pick may be divided by the numeric value of the offer the user received on the prop pick. The value calculated from the offer and the assigned number of points may then be credited to the user's account of points.

At 135, a determination is made as to whether or not the contest that the user has entered is still open. If the contest is still open, the processing of flowchart 100 returns to 110, where the user is allowed to make additional prop picks. Furthermore, if the user successfully predicted the outcome of a prop pick previously entered in 110, the additional points added to the user's account in 130 will be available for the user to access when submitting and accepting additional prop picks. Accordingly, the contest that the user is participating in flowchart 100 may be described as an “active” contest as the user can “reinvest” his or her “winnings” by using the awarded points when accepting offers on additional prop picks.

It will be understood by those skilled in the art that the reference numerals 115-135 may take place in parallel with each other, or may take place in an order different than what is illustrated in FIG. 1. For example, a user may make numerous prop picks before finding out the results of previously submitted prop picks. Furthermore, users may submit additional prop picks as the results of their previous prop picks are being determined, and while the current ranking of the users is being determined.

The processing of reference numerals 110-135 will continue until the user reaches 135 at a time after the contest has closed. Upon the closing of the contest, the participants will be ranked, and the user will be provided with his or her rank in 140. The ranking may take place according to different metrics, depending on the contest. Similarly, multiple rankings may be provided for a single contest. For example, the users within a contest may be ranked based on the total number of points accumulated, the total number of prop picks predicted correctly, and/or the average number of points received per prop pick, among others. Furthermore, the contestants may be provided with an award based on their ranking. For example, a monetary award may be provided to participants with certain rankings within each contest. Specifically, monetary awards may be provided for the first, second and third place ranked contestants in each contest. Once the contest closes and the user receives his or her rank, the processing ends in 145.

The processing described above may be carried out by a user accessing a server computer through the use of a user network connected device. The user network connected device may be embodied in a personal computer, a tablet computer, a smartphone, and others known to those skilled in the art.

The process of FIG. 1, when utilized by a particular user, could result in the following specific scenario:
1. A player deposits $50 to be used as entrance fees to different contests.
2. The player pays a $25 entry fee into a daily contest, such as a contest that allows players to make prop picks based on football and basketball games that are to take place on a particular day.
3. The player receives a starting in-contest points balance of 100 points.
4. The player makes a first customized pick, such as a head-to-head pick of: “Tom Brady will have more touchdown passes than Payton Manning”
5. The player is offered a system-generated offer of “2.50” for this pick.
6. The player accepts the offer and elects to assign 20 points to this pick. By accepting the pick, the player's in-contest points balance declines to 80 points.
7. The football games in which Tom Brady and Peyton Manning are competitors are played, and the outcome of the player's prop pick is determined.
8. The player successfully predicted the outcome of the prop pick and receives 50 points, as the assigned 20 points multiplied by the offer of “2.50” equals 50 points. The player's in-contest points balance is increases to 130 points.
9. The player makes additional picks, assigning their original points and reinvesting the points acquired from successful prop picks, resulting in an in-contest points balance of 320 points.
10. The player finishes 10th on the final leaderboard and wins a cash prize of $150.
11. The player's real-money wallet increases by $150, resulting in a new balance of $175.

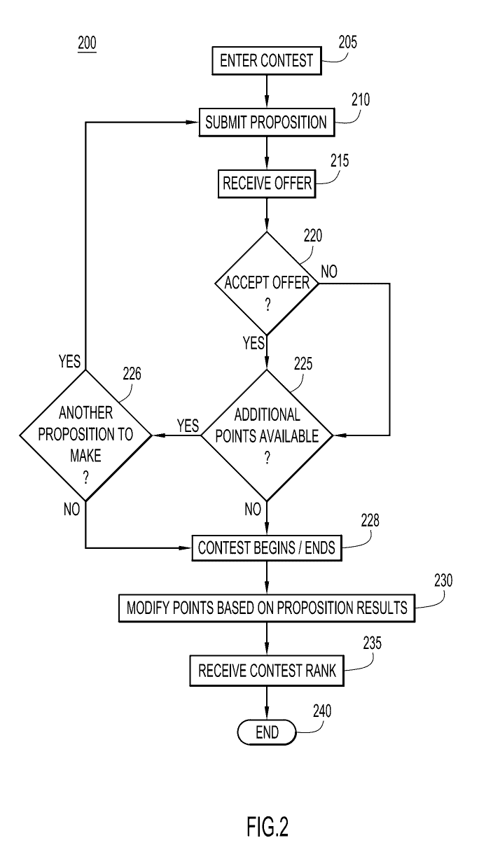

With reference now made to FIG. 2, depicted therein is a flowchart 200 similar to that of flowchart 100 of FIG. 1 in that it depicts a process for competing in a game according to the techniques described herein, in which the user selects his or her own prop picks. Flowchart 200 differs from that of flowchart 100 of FIG. 1 in that it depicts an “inactive” competition. As used herein an “inactive” competition is one in which the users are not able to “reinvest” the points they receive in response to correctly determining the outcome of one or more of their prop picks. In other words, an inactive competition may have a defined start date, and competitors draw down their allocated points prior to the contest beginning. Accordingly, each competitor will have the same number of points to assign to prop picks for the competition regardless of the outcome of their picks, as will be described in greater detail below.

The beginning of flowchart 200 is analogous to that of flowchart 100 of FIG. 1. Specifically, the user enters the contest in 205, submits a prop pick in 210, receives an offer in 215, and either accepts or rejects the offer in 220. The “inactive” nature of the contest of flowchart 200 becomes apparent with 225 where a user is given the option of making another prop pick. As can be seen with 225, this decision is made, and will continue to be made, prior to the contest being opened. Accordingly, users will be given the opportunity to make prop picks until their point total is extinguished. So long as the user still has points available and still wishes to make prop picks, the processing will loop through reference numerals 210-225.

Once the user either runs out of points or no longer wants to make additional prop picks, the processing of flowchart 200 moves to 228, where the contest opens and closes. Specifically, the contest opens once the events upon which the prop picks are based begin, and once all of the events have completed (i.e., once all of the results of the prop picks are known), the contest closes. While the example of FIG. 2 has the user making all of his or her prop picks prior to the contest opening (i.e., prior to any of the events that serve as the basis for the outcome of the prop picks), other example contests may allow users to continue to make picks after the contest has opened so long as the user is not permitted to “reinvest” any points awarded as a result of the outcome of a previous prop pick, and so long as the events that may impact the outcome of the particular prop pick have not yet begun.

At 230 the user's point total is modified based on the outcome of his or her prop picks. For example, the number of points the user assigned to a pick may be multiplied by the offer the user received on the prop pick. In 235 the user receives his or her rank relative to the other players in the contest. As with the example of FIG. 1, the ranking may take place according to different metrics, depending on the contest. Finally, in 240 the processing ends.

As with the example of FIG. 1, the processing of FIG. 2 may be carried out by a user accessing a server computer through the user of a user network connected device. The user network connected device may be embodied in a personal computer, a tablet computer, a smartphone, and others known to those skilled in the art.

The process of FIG. 2, when utilized by a particularly user, could result in the following specific scenario:
1. A player deposits $50 to be used as entrance fees to different contests.
2. The player pays a $25 entry fee into a contest that allows the player to make prop picks based on football and basketball games that are to take place on a particular day. According to this particularly example, the contest has a start date of Oct. 1, 2015. This date will serve as both a start date for the events on which the player can base prop picks and the cut-off date by which the user must make his or her prop picks.
3. The player receives an in-contest points balance of 100 points.
4. The player makes a total of five user-defined picks using his entire balance of 100 points prior to the contest start date of Oct. 1, 2015, i.e., prior to the cut-off time.
5. At the end of the contest the player ends up correctly predicting the outcome of three of his or her prop picks, but unsuccessfully predicts the outcome of two of his or her prop picks.
6. The net result of the player's prop picks is a final balance of 140 points.
7. The player finishes 5th on the final leaderboard and wins a cash prize of $100.
8. The player's real-money wallet increases by $100, increasing the balance from $25 to a new balance of $125.

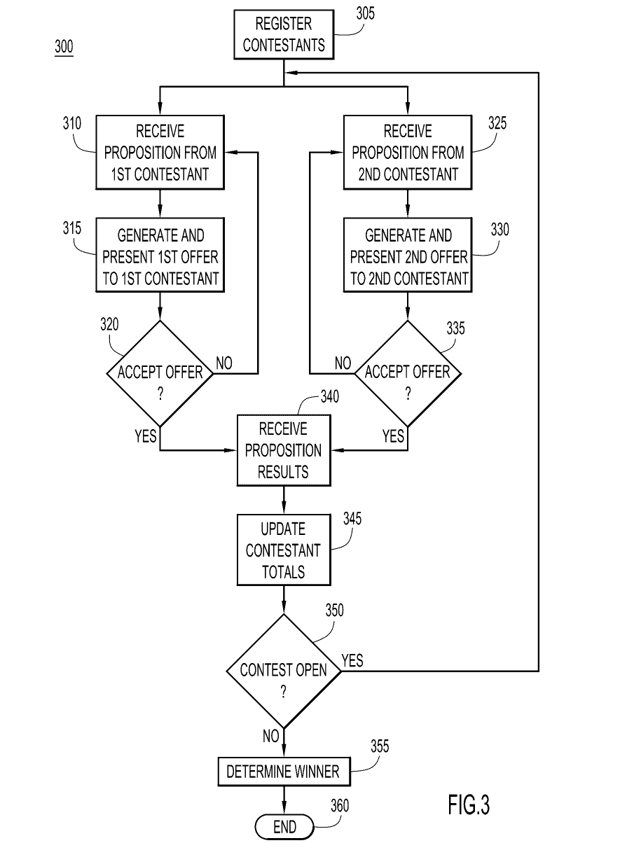

With reference now made to FIG. 3, flowchart 300 illustrates an active contest, like that of FIG. 1, but instead of illustrating the processing from the user's perspective, the processing is illustrated from the perspective of the entity or system that is hosting the contest. The contest begins in 305 as contestants or users are registered. According to the specific example of FIG. 3, at least two users enter the contest in 305.

In 310 a first prop pick is received from a first contestant and/or user. In 315 an offer for the prop pick is generated and presented to the user. For example, the offer may be generated by a system such as that described in U.S. patent application Ser. No. 13/771,725 (U.S. Pre-Grant Publication No. 2013/0304633), the contents of which are hereby incorporated by reference. In 320, the system receives an indication as to whether or not the user has accepted the offer generated and presented in 315. If the user accepts the offer, the acceptance received in 320 may include a number of points that the first user would like to assign to the prop pick received in 310. The system that generates the offer in 315 may be hosted on a server computer that is accessed by a user network connected device.

At the same time that the system is receiving prop picks from the first user in reference numerals 310-320, the system may also be receiving prop picks from a second user through reference numerals 325-335. While flowchart 300 illustrates only two users, real world embodiments may have many tens, hundreds, or even thousands of users.

At 340, results of the different prop picks are received. For example, the events upon which one or more of the first user's and the second user's prop picks are based may have completed, allowing the outcome of the prop picks to be determined. In 345, the users' point totals will be updated based on the outcome of their respective prop picks. For example, the number of points each user assigned to his or her prop picks in steps 310-320/325-335 may be multiplied by the offer each user received on his or her prop pick in 315/330, respectively. This value may then be credited to each user's account of points.

In 350, if the contest is still open, the process will allow the first user and the second user to continue to present prop picks until the contest closes. Once the contest closes, a winner for the contest is determined in 355. For example, the winner may be determined between the first user and the second user based on which of the two users has the higher total point value. Determining the winner may also include awarding the users based on their respective ranking among the total number of users. Finally, in 360 the processing of flow chart 300 completes.

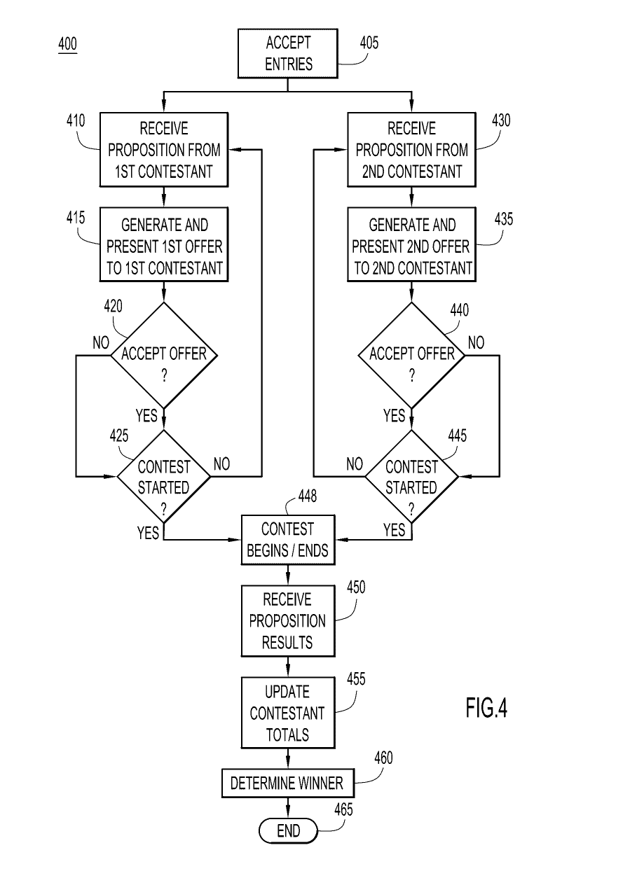

With reference now made to FIG. 4, depicted therein is flowchart 400 which illustrates an inactive contest, like that of FIG. 2, but instead of illustrating the processing from the user's perspective, the processing is illustrated from the perspective of the entity or system that is hosting the contest. The contest begins in 405 when the system begins registering contestants and/or users. Unlike 305 of FIG. 3, the processing of flowchart 400 begins prior to the “starting” of the contest, as the users in the contest will allocate their points to prop picks prior to the contest starting, i.e., prior to a specific date after which no more prop picks may be made. According to the specific example of FIG. 4, at least two users enter the contest.

In 410 a first prop pick is received from a first contestant and/or user. In 415 an offer for the prop pick is generated and presented to the user. As with flowchart 300 of FIG. 3, the offer may be generated by a system such as that described in U.S. patent application Ser. No. 13/771,725 (U.S. Pre-Grant Publication No. 2013/0304633). As with the example of FIG. 3, the system that generates the offer in 415 may be hosted by a server computer that is accessed by a user network connected device.

In 420, the system receives an indication as to whether or not the user has accepted the offer generated and presented in 415. If the user accepts the offer, the acceptance received in 420 may include a number of points that the first user would like to assign to the prop pick received in 420. At 425, a determination is made as to whether or not the contest has started, i.e., whether the date after which no more prop picks may be made has been reached. If the date has not yet been reached, the processing of steps 410-425 may be repeated until the start date is reached and/or the first user uses all of the points that they have been allocated for the contest of FIG. 4.

At the same time that the system is receiving prop picks from the first user in reference numerals 410-425, the system may also be receiving prop picks from a second user through reference numerals 430-445. While flowchart 400 illustrates only two users, real world embodiments may have many tens, hundreds, or even thousands of users.

In 448, the contest begins, meaning the events upon which the users' prop picks are based begin taking place, and subsequently ends with all of the events having been completed. Once the contest starts and ends, results of the different prop picks are received at 450. For example, the event upon which one or more of the first user's and the second user's prop picks are based will have completed, allowing the outcome of the prop picks to be determined. In 455, the users' point totals will be updated based on the outcome of their respective prop picks. For example, the number of points each user assigned to his or her prop picks in steps 410-425/430-445 may be multiplied by the offer each user received on his or her prop pick in 420/440, respectively. This value may then be credited to each user's account of points.

Once the users' totals are updated, a winner for the contest is determined in 460. For example, the winner may be determined between the first user and the second user based on which if the two users has the higher total point value. Determining the winner may also include awarding the user a monetary award based on their respective ranking among the total number of users. Finally, in 465 the processing of flow chart 300 completes.

While the processing illustrated in FIGS. 1-4 and described above is discussed with reference to “active” and “inactive” contests, the techniques described herein may also be applied to other types of contests. For example, the techniques described herein may also be applied to “championship cup” tournaments. In “championship cup” tournaments, specific contests may be designated as part of a championship series. A player who enters one or more of these championship series contests will receive a score for each individual contest. These individual contest scores will then be tallied to form a separate “championship cup” score. The “championship cup” tournament will maintain its own leaderboard and the winners will be those with the highest accumulated points across the plurality of contests that are part of the “championship cup” series. According to other examples, a user's rank within each of the “championship cup” series contests will be used to determine rank relative to other contestants. For example, a user may receive a particular number of points for a first, second or third place finish within a contest. These points may then be accumulated over a plurality of contests to determine a “championship cup” series winner. In other words, the ranking of the users may be based on a cumulative number of prop picks within a single contest, a cumulative number of prop picks across a plurality of contest, or an accumulated ranking within a plurality of contests.

The techniques described herein may also be applied to “points chaser” contests. In “points chaser” contests, a target point balance is set. Players attempt to reach the target point balance within a particular timeframe. Any player that reaches the target balance within the time frame may be rewarded. Additional awards may be granted to players who reach the point total first, or before a certain percentage of the other contestants.

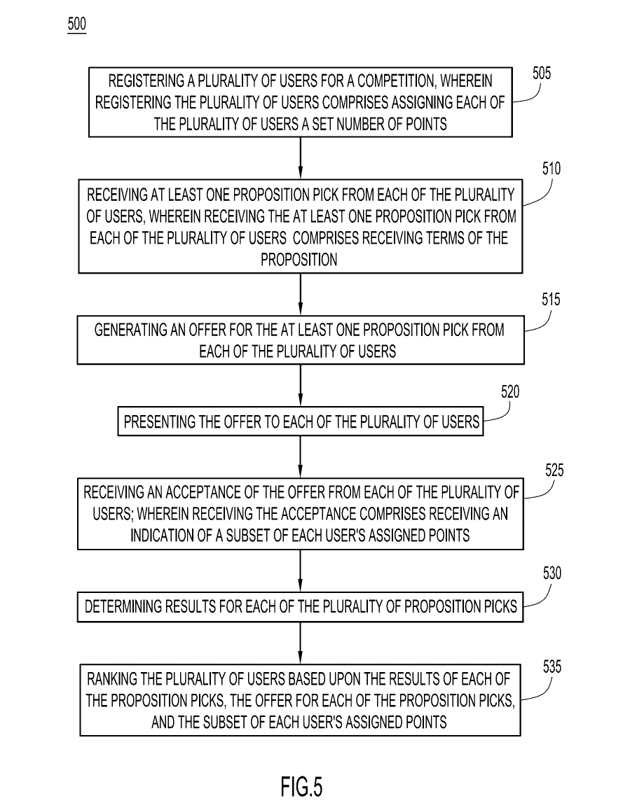

Turning to FIG. 5, the processing performed by the system and or host of the contest for both active, inactive and the other contests described herein can be generalized to flowchart 500. Specifically, processing of the system and/or host of a contest may include the following processing steps.

In 505, a plurality of users are registered for a competition. The registration of the users comprises assigning each of the plurality of users a set number of points. In 510, at least one proposition pick is received from each of the users of the plurality of users. In 515, offers are generated for each proposition pick received from each of the users of the plurality of users. These offers are then presented to the users in 520. If the users accept the offers, an acceptance is received from each user at 525. According to the techniques described herein, receiving an acceptance of the offer may also include receiving a number of the points that were assigned to the user in 505. These points may serve as a scaling factor. For example, if a user is very confident in his or her proposition pick, he or she may assign a high number of points to the pick, thereby scaling or increasing the benefit they will receive if they correctly predicted the outcome of the proposition pick.

In 530, results are determined for each of the plurality of proposition picks. Finally, in 535, the plurality of users are ranked based upon the results of each of the proposition picks, the offer for each of the proposition picks, and the subset of the users' assigned points. The ranking in 535 may be based on a cumulative number of proposition picks over a predetermined period of time.

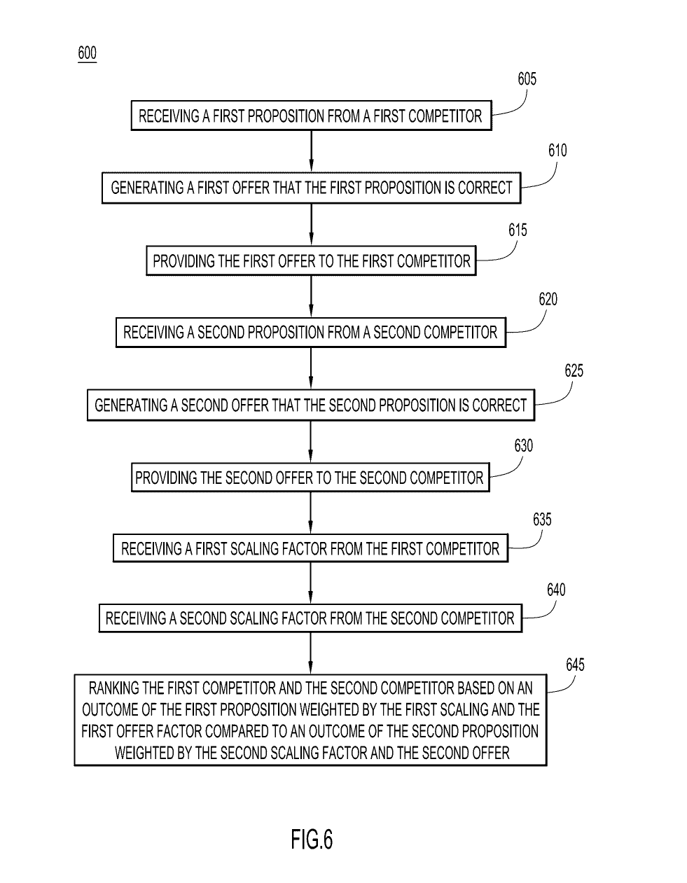

With reference now made to FIG. 6, depicted therein is flowchart 600 that illustrates another formulation of the techniques described herein. Flowchart 600 begins at 605 where a first proposition or prop pick is received from a first competitor. A first offer for the first proposition is generated in 610, and the first offer is provided to the first user in 615. In 620, a second proposition or prop pick is received from a second user. An offer for the second proposition is generated in 620, and the second offer is provided to the second user in 630.

In 635, a first scaling factor is received from the first competitor. According to the examples described above with reference to FIGS. 1-4, the first scaling factor may be embodied in a number of points assigned to the first proposition by the first user. Because the examples of FIGS. 1-4 multiple the offer by the number of points a user assigned or “wagered” on a proposition, the number of points a user assigns to a proposition serves to scale or multiply the benefit achieved by successfully predicting the outcome of the proposition. In 640, a second scaling factor, e.g., a number of points to be assigned to the second proposition, is received from the second user.

Finally, in 645, the first and second competitors are ranked based on an outcome of the first proposition weighted by the first scaling factor and the first offer compared to an outcome of the second proposition weighted by the second scaling factor and the second offer.

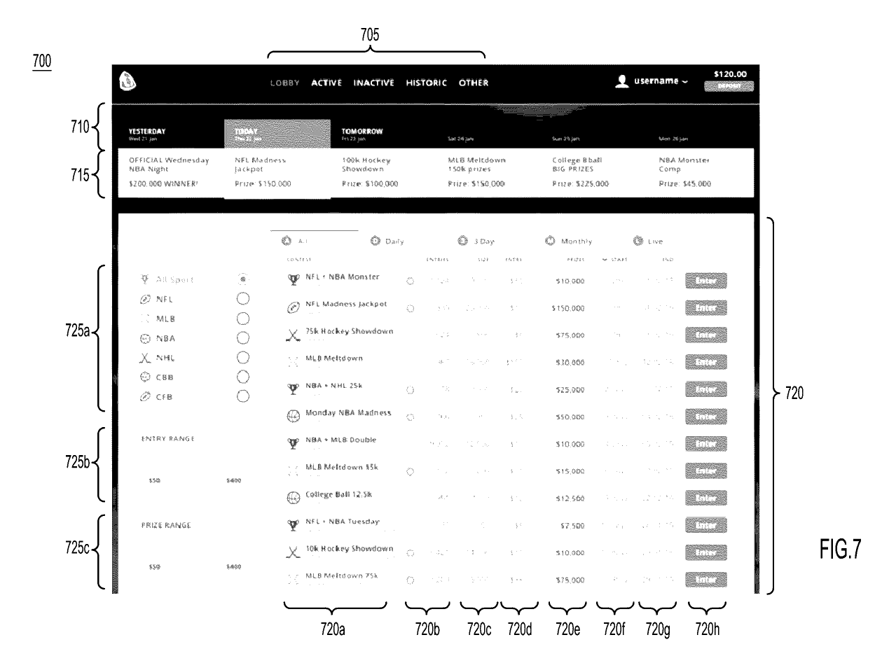

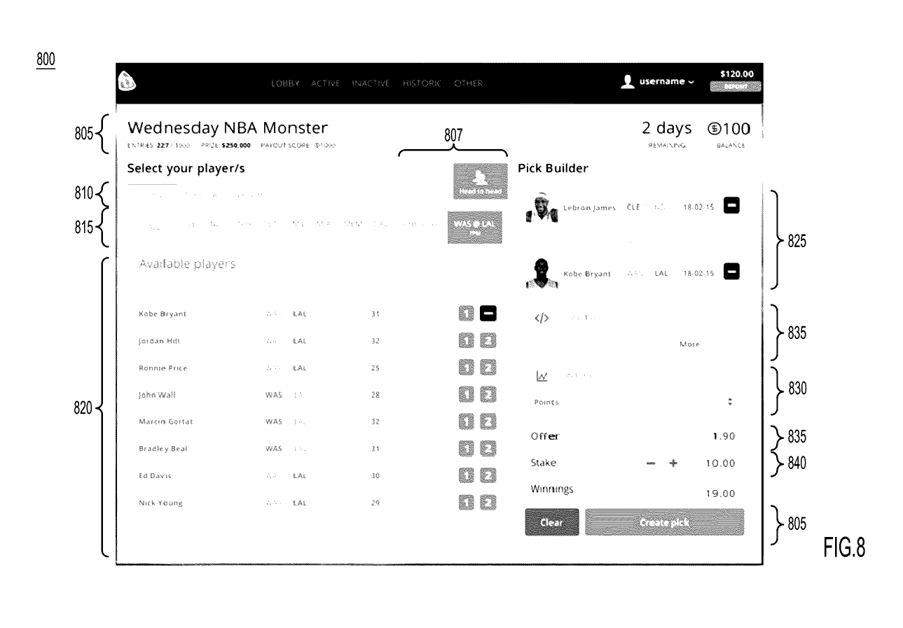

In order to facilitate the competitions and contests described herein, interactive game boards and/or interactive gaming displays will be described with reference to FIGS. 7 and 8. The boards or displays illustrated in FIGS. 7 and 8 may take the form of web pages generated at server computer which provided to a user device over a network. According to other examples, the framework and organization of the displays may be programmed into a dedicated application or “app” that executes on a user device, such as a personal computer, a tablet computer, a smartphone, and others known to those skilled in the art. The specific values displayed in with in the framework of the display may be dynamically updated and changed based on data and/or traffic received over a network from a server computer.

Turning first to FIG. 7, depicted therein is an interactive game board 700 that allows users to select contests in which to compete. Specifically, game board 700 provides a display of games and options, allowing users to select from a plurality of different possible game types (e.g., active, inactive, “championship cup,” “points chaser,” etc.), game subjects (e.g., football, baseball, basketball, hockey, etc.), game entry fees, and game prize amounts. Game board 700 includes game type navigation portion 705. By selecting the options presented in navigation portion 705, a user can select the type of game in which they would like to participate. According to the example of FIG. 7, the user can select from “active” games, “inactive” games, “historic” games, and “other” games. Date selection section 710 allows users to view games from a particular day or date. Game board 700 also includes featured games section 715. Featured games section 715 allows the host of the competitions to present games that they believe may be of particular interest to users of game board 700. According to the example of game board 700, the featured game section 715 is incorporated within date selection section 710 so that there is a featured game for each day of date selection section 710.

Games section 720 provides a list of available games of the type indicated by game-type navigation section 705 for the day or date indicated by date selection section 710. Games section 720 includes informational columns 720a-g, and functional column 720h. The information columns 720a-g provide information about each game listed in games section 720. Column 720a provides a name for each game. Column 720b indicates the number of current participants in the game, while column 720c indicates the maximum number of allowed participants. Column 720d indicates the entry fee to join the game, while column 720e indicates the total amount of available prize money in the game. Columns 720f and 720g indicate the start and end dates for the game, respectively. Functional column 720h, on the other hand, provides a button that allows users to join each displayed game.

Filtering portions 725a-c allow users to filter the games that appear in games section 720 based on different criteria. For example, filtering portion 725a allows users to limit the games that appear in games section 720 by the particular sport to which the games apply. Filtering area 725b allows users to select an entry fee range, and once selected, only games with an entry fee within that range will appear in games section 720. Finally, filtering section 725c allows users to set a prize range, and once selected, only games with prizes within that range will appear in games section 720.

With reference now made to FIG. 8, depicted therein is a proposition or prop pick builder 800. Prop pick builder 800 is an interactive game board that allows users to build custom prop picks for submission to a particular game or contest. Prop pick builder 800 includes game indicator 805 that identifies the current game that the user is participating in. For example, game indicator 805 will indicate the game that the user selected from game board 700 of FIG. 7. Prop pick type section 807 allows the user to select a particular type of prop pick to build.

Because the selected game is a basketball themed game, the rest of prop pick builder 800 is populated with the elements that are necessary to construct custom prop picks based on basketball games. These contents may be communicated to a user network connected device through traffic sent over a network from a server device. Date section 810 lists the dates during which basketball games are being played that are part of the user's current contest. Games section 815 list the basketball games that are being played on the dates listed in date section 810, and player section 820 lists the basketball players competing in the basketball games listed in games section 815. By selecting games and players from sections 815 and 820, respectively, users can select the subjects for their custom prop picks. The players selected from players section 820 appear in selected player section 825. Statistics section 830 allows users to select statistic for the prop pick being built, while condition section 835 allows the user to select a condition to apply to the statistic selection selected in section 830.

Offer portions 835 displays the offers generated by the game hosting system in real-time as the prop pick is being built. This allows a user to see how the offers change as the different values are being selected. In order to display the correct value in offer portions 835, prop pick builder 800 may be in communication with a server device, transferring the user's current selections to the server. The server will return the offer for the user's current selections. According to some examples, this communication between the user network connected device and the server takes place automatically as the user changes his or her selections. According to other examples, the user will take some action to indicate that they have completed building a prop bet and he or she is ready to view the corresponding offer. For example, the user may be required to click a button to indicate that he or she has finished building a prop bet and would like to see the system generate odds.

Stake or points section 840 allows a user to set the number of points they would like to assign to the prop pick. In other words, stake or points section allows the user to set the scaling factor for the prop pick. Finally, the user can accept the prop pick by selecting the “Create Pick” button 845.

According to the specific example of FIG. 8, when all of the selections in prop pick builder 800 are combined, a user-defined prop pick is constructed in which the user proposes a head-2-head prop pick that Lebron James will score more points in the “Cleveland vs. Indiana” game than Kobe Bryant will score in the “Washington vs. Los Angeles” game. The contest host system generates an offer or odds of “1.90 to 1” that the user's prop pick will turn out to be true, and the user assigns 10 points to this prop pick.

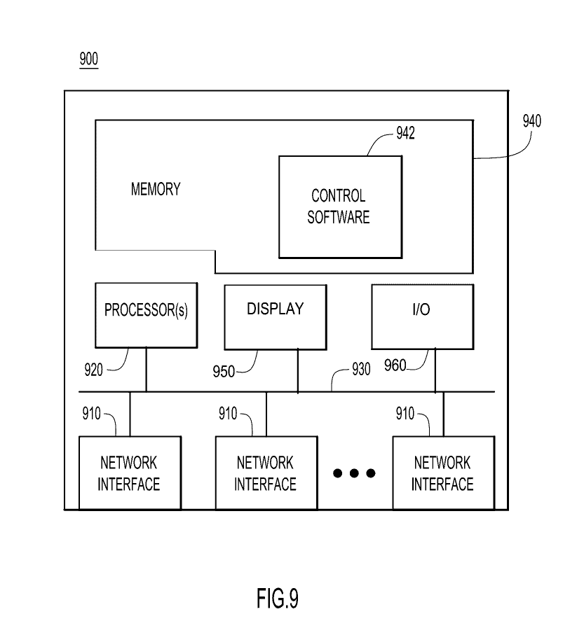

With reference now made to FIG. 9, an example block diagram is shown of a device 900, and device 900 may be any one of a user equipment device or a server used to host the contests described above with reference to FIGS. 1-8. Accordingly, device 900 is configured to perform the techniques described herein. Device 900 includes network interfaces 910 which may be used to connect to other devices. Accordingly, network interfaces 910 may be embodied as wired or wireless interfaces. One or more processors 920 are provided to coordinate and control device 900. The processor 920 is, for example, one or more microprocessors or microcontrollers, and it communicates with the network interfaces 910 via bus 930. Memory 940 stores software instructions 942 which may be executed by the processor 920. For example, control software 942 for device 900 includes instructions for performing the competition and/or game processes, as described above with reference to FIGS. 1-8. In other words, memory 940 includes instructions for device 900 to carry out the operations described above in connection with FIGS. 1-8.

Memory 940 may include read only memory (ROM), random access memory (RAM), magnetic disk storage media devices, optical storage media devices, flash memory devices, electrical, optical or other physical/tangible (e.g. non-transitory) memory storage devices. Thus, in general, the memory 940 may be or include one or more tangible (non-transitory) computer readable storage media (e.g., a memory device) encoded with software comprising computer executable instructions. When the instructions of the control software 942 is executed (by the processor 920), the processor is operable to perform the operations described herein in connection with FIGS. 1-8.

Device 900 may also include display 950 used to, for example, display game boards like game board 700 and game board 800 of FIGS. 7 and 8, respectively. According to example embodiments, device 900 may serve as a user or competitor network connected device that receives network traffic from a server or competition host device over network interfaces 910. Processor 920 will convert the received traffic into signals that can be displayed by display 950. Also included in device 900 are input/output devices 960 that allow users to interact with game boards. For example, I/O device 960 allows users to make selections in game board 700 and game board 800 of FIGS. 7 and 8, respectively. Processor 920 will interpret these selections, and send indications of the selections as network traffic to a host or server device via network interfaces 910.

The above description is intended by way of example only.

What is claimed is:

1. A method of hosting a competition for a plurality of users, the method comprising:
registering, via a network connected device for each of the plurality of users, the plurality of users for the competition, wherein registering the plurality of users comprises assigning each of the plurality of users a set number of points;
receiving, via the network connected device for each of the plurality of users, at least one proposition pick from each of the plurality of users, wherein receiving the at least one proposition pick from each of the plurality of users comprises receiving terms of the proposition and at least a subset of each user's assigned points;
generating an offer for the at least one proposition pick from each of the plurality of users;
presenting the offer for the at least one proposition pick from each user to each of the plurality of users via the network connected device for each of the plurality of users;
receiving, via the network connected device, for each of the plurality of users, an indication of whether the offer to each of the plurality of users has been accepted;
determining results for each of the proposition picks accepted; and
ranking the plurality of user based upon the results of each of the proposition picks, the offer for each of the proposition picks, and the subset of each user's assigned points.

2. The method of claim 1, further comprising assigning additional points to at least one of the plurality of users based on the determining of the results for each of the proposition picks.

3. The method of claim 2, further comprising receiving at least one other proposition pick, wherein receiving the proposition pick comprises receiving a subset of the additional points.

4. The method of claim 1, wherein receiving the at least one proposition pick from each of the plurality of users comprises establishing a start date, wherein each of the plurality of user must associated his set number of points with proposition picks prior to the start date.

5. The method of claim 1, wherein receiving the at least one proposition pick from each of the plurality of users comprises:
determining a start date and an end date for the competition; and
receiving proposition picks from the plurality of users on an ongoing basis during a period between the start date and the end date of the competition.

6. The method of claim 1, wherein ranking the plurality of users comprises assigning points to each of the plurality user based upon the results of each of the proposition picks, the offer for each of the proposition picks, and the subset of each user's assigned points.

7. The method of claim 6, wherein the points for each of the plurality of users are added to a total of points for the user, wherein the total of points for each user comprises a total of points from a plurality of competitions.

8. The method of claim 7, further comprising awarding at least one of the plurality of users when the total of points for the at least one of the plurality of users reaches a predetermined threshold.

9. The method of claim 1, wherein receiving the at least one proposition pick from each of the plurality of users comprises receiving a selected proposition pick from a plurality of predetermined proposition picks.

10. The method of claim 1, wherein receiving the subset of each user's assigned points comprises receiving the subset of each user's assigned points after presenting the offer for the at least one proposition pick from each user to each of the plurality of users.

11. A method of playing a game, comprising:
receiving, via a first network connected device, a first proposition from a first competitor;
generating a first offer indicating a first value associated with a successful outcome of the first proposition;
providing, via the first network connected device, the first offer to the first competitor;
receiving, via a second network connected device, a second proposition from a second competitor;
generating a second offer indicating a second value associated with a successful outcome of the second proposition
providing, via the second network connected device, the second offer to the second competitor;
receiving from the first competitor via the first network connected device, an acceptance of the first offer and a first scaling factor associated with the first proposition;
receiving from the second competitor via the second network connected device, an acceptance of the second offer and a second scaling factor associated with the second proposition; and
ranking the first competitor and the second competitor based on an outcome of the first proposition weighted by the first scaling factor and the first value compared to an outcome of the second proposition weighted by the second scaling factor and the second value.

12. The method of claim 11, further comprising:
assigning a number of points to the first competitor, and
assigning the number of points to the second competitor;
wherein receiving the first scaling factor comprises receiving at least a first portion of the number of points from the first competitor; and
wherein receiving the second scaling factor comprises receiving at least a second portion of the number of points from the second competitor.

13. The method of claim 11, wherein
receiving the first proposition comprises receiving a first prediction; and
receiving the second proposition comprises receiving a second prediction.

14. The method of claim 13, wherein:
receiving the first prediction comprises receiving a predicted occurrence or non-occurrence of an event during a first sporting event; and
receiving the second prediction comprises receiving a predicted occurrence or non-occurrence of an event during a second sporting event.

15. The method of claim 11, wherein ranking the first competitor and the second competitor comprises assigning the first competitor a first additional number of points based on the outcome of the first proposition weighted by the first scaling factor; and assigning the second competitor a second additional number of points based on the outcome of the second proposition weighted by the second scaling factor.

16. The method of claim 15, further comprising:
receiving a third proposition from the first competitor;
generating a third offer indicating a third value associated with a successful outcome of the third proposition;
providing the third offer to the first competitor;
receiving a third scaling factor from the first competitor.

17. The method of claim 16, wherein the first proposition, the second proposition and the third proposition are received prior to the outcome of the first proposition being known, prior to the outcome of the second proposition being known, and prior to an outcome of the third proposition being known.

18. The method of claim 17, wherein the outcome of the first proposition is known prior to receiving the third proposition.

19. The method of claim 11, wherein receiving the first proposition comprises receiving a proposition selected by the first competitor from a plurality of propositions provided to the first competitor.

20. The method of claim 1, wherein ranking the first competitor and the second competitor comprises evaluating outcomes of a plurality of propositions provided by the first competitor scaled by a corresponding plurality of first scaling factors against outcomes of a plurality of propositions provided by the second competitor scaled by a corresponding plurality of second scaling factors.
